(19) United States
(12) Patent Application Publication
(10) Pub. No.: US 2001/0017657 A1
(43) Pub. Date: Aug. 30, 2001

(54) Information input apparatus and method

(75) Inventors: Yousuke Kowno, Yokohama-shi (JP); Akira Ohmura, Kawasaki-shi (JP)

Correspondence Address: OLIFF & BERRIDGE, PLC, P.O. Box 19928, Alexandria, VA, 22320, US

(73) Assignee: NIKON CORPORATION

(21) Appl. No.: 09/851,125

(22) Filed: May 9, 2001

Related U.S. Application Data
(63) Continuation of application No. 08/873,180, filed on Jun. 11, 1997.

(30) Foreign Application Priority Data
Jun. 12, 1996 (JP) 08/150756

(51) Int. Cl. H04N 5/228

(52) U.S. Cl. 348/231; 348/222

(57) ABSTRACT

An information input apparatus and method is provided, by which newly shot images can be recorded in an electronic camera or other device, while other images are being displayed. If a specified image is shot while an image that is recorded in memory is being displayed on display mode, the image that is shot is overwritten from an address in a area in which the image which is being displayed is recorded. On the other hand, when a specified image is shot in recording mode, the image that is shot is added from an address in an unrecorded area of the memory card to which no images have been recorded.

### BACKGROUND OF THE INVENTION

1. Field of Invention

The present invention relates to an information input apparatus appropriate for use in electronic cameras or the like, which converts images of objects into digital data to store and process.

2. Description of Related Art

Recently, electronic cameras have been used instead of cameras using film. Electronic cameras shoot images of objects using CCDs or other devices and convert the images into digital data, to store that data in a memory built into the camera or in a memory card that is detachable from the camera. Images that are shot using an electronic camera can be immediately displayed on a screen, such as an LCD, without developing and printing the film which is necessary using conventional cameras.

In addition, because the shot images are recorded as digital data, the electronic camera also has good compatibility with personal computers and can be used as an input device to such computers. For example, when creating a home page for the Internet, an electronic camera can be used as a tool to input image data to that home page.

However, in a conventional electronic camera, if an image of an object is shot while an image recorded in a memory is being displayed, because there are no functions by which the image that has just been taken is overwritten onto the screen image being displayed, there are problems in handling and operation. For example, the user must clear the image from the display, and then the new object is shot after changing to an imaging mode to record the image of the object. Because of this, there are cases when shutter chances (chances to shoot the image at the right time) are missed.

### SUMMARY OF THE INVENTION

The invention was developed considering the problems discussed above, and has as one object the ability help a user avoid missing shutter chances. Another object of the invention is to simplify operation so that the image of the object is overwritten on the image being displayed when the image of the object is shot during display (reproduction) of the prior image.

The invention achieving these and other objects relates to, in one aspect, an information input apparatus including an imaging part (for example, a shooting lens 3 in FIG. 1 and a CCD 20 in FIG. 3) for shooting images of desired objects, memory (for example, a memory card 24 in FIG. 3) for storing the images shot by the imaging part, a reproducing (playing) part (for example, compression/decompression memory control circuit 38) for reproducing the images stored in the memory, a controlling part (for example, a CPU 34 in FIG. 4) for storing the images shot by the imaging part into the memory and for reproducing (playing) a predetermined one of the images stored into the memory on the reproducing part, a first instruction part (for example, a release switch 10 in FIG. 1) for instructing the controlling part to store the images shot by the imaging part to the memory, and a second instruction part (operation keys 7 in FIG. 2) for instructing the reproducing part to reproduce a predetermined one of the images stored in the memory, wherein the controlling part stores in the memory the images shot by the imaging part when there is an instruction from the first instruction part to store in the memory the images shot by the imaging part, while the reproducing part is reproducing a predetermined one of the images instructed by the second instruction part.

In addition, the controlling part overwrites the image shot by the imaging part in a predetermined area of the memory in which the predetermined one of the image that the reproducing part is reproducing is recorded, when there is an instruction from the first instruction part to store in the memory the images shot by the imaging part, while the reproducing part is reproducing a predetermined one of the images instructed by the second instruction part.

The invention can further comprise a screen display (for example, a LCD 6 in FIG. 2) for displaying the images shot by the imaging part and stored in the memory. The invention can also further comprise an illumination part (for example, a light emission part 4 in FIG. 1) for irradiating illuminating light to said object. The invention can also further comprise a sound input part (a microphone 1 in FIG. 1) for inputting predetermined sound(s), and the memory can store the sound input from the sound input part. The memory relates and stores the images and the sounds.

In one aspect of the information input apparatus described herein, the imaging part shoots images of a desired object. The memory stores the images shot by the imaging part. The reproducing part reproduces the images stored in the memory. The controlling part controls the storage of images shot by the imaging part into the memory, as well as reproduction of a predetermined one of the images stored into the memory in the reproducing part, and the first instruction part instructs the controlling part to store the images shot by the imaging part into the memory. The second instruction part instructs the reproducing part to reproduce the specified one of the images stored in the memory. And, the controlling part stores in the memory the images shot by the imaging part, when there is an instruction from the first instruction part to store in the memory the images shot by the imaging part, while the reproducing part is reproducing a predetermined one of the images instructed by the second instruction part. Therefore, new images can be shot even during the reproduction of prior taken images.

### BRIEF DESCRIPTION OF THE DRAWINGS

FIG. 1 is a front perspective view of an embodiment of the electronic camera to which the invention is applied;

FIG. 2 is a rear perspective view of the electronic camera of FIG. 1;

FIG. 3 shows an example of a construction inside the electronic camera of FIG. 1;

FIG. 4 is a block diagram showing an example of an electric construction inside the electric camera of FIG. 1;

FIG. 5 shows an example of display screen shown in the LCD 6 of the electronic camera of FIG. 1;

FIG. 6 is a flow chart showing an example of operation when there is an instruction for shooting an image while another image is being displayed;

FIG. 7 shows an arrangement of the image data recorded in a memory card 24 and unrecorded areas; and

FIG. 8 is a flow chart showing another example of operation when there is an instruction for shooting an image while another image is being displayed.

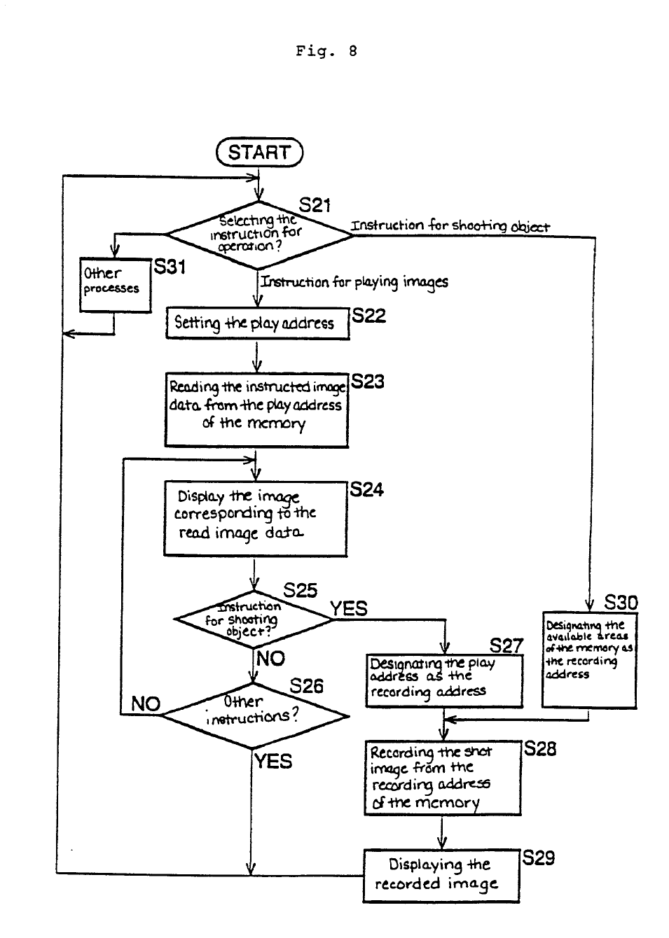

### DETAILED DESCRIPTION OF PREFERRED EMBODIMENTS

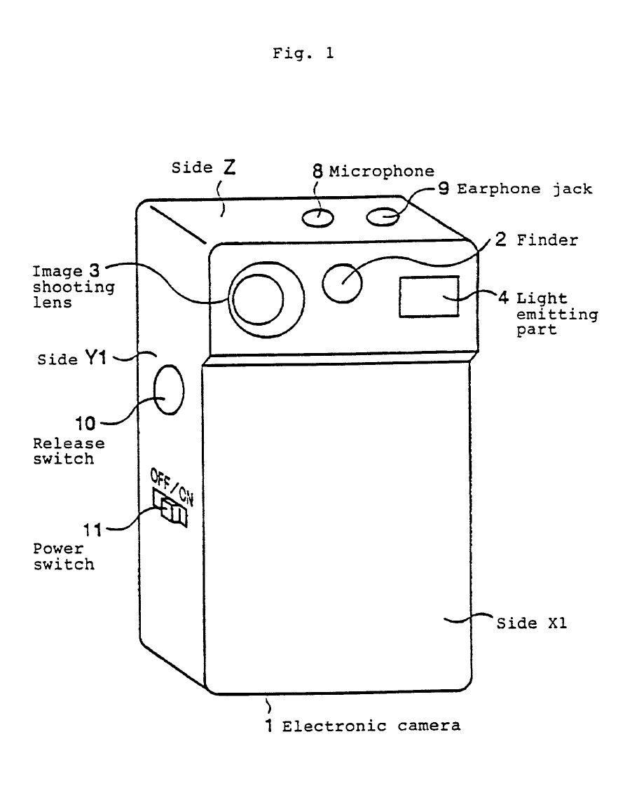

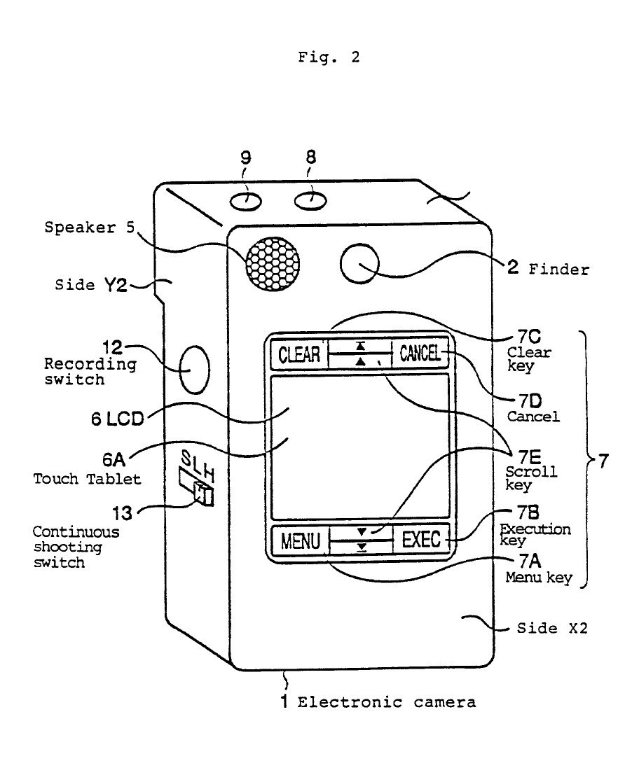

FIGS. 1 and 2 are perspective views showing the structure of an embodiment of an electronic camera used with the invention. For ease of explanation, among the six sides or faces composing a electronic camera 1, a side facing the object is designated as a side X1, and a side facing the user is designated as a side X2. On the upper end of the side X1, a finder used for confirming the shooting area of the object, a shooting lens for taking in optical (light) images of the object, and a light emission part (strobe flash) for illuminating the object are provided.

On the upper end of the side X2 opposite to the side X1 (a position corresponding to the upper end of the side X1 at which the finder 2, shooting lens 3, and light emitting part 4 are formed), finder 2 and a speaker 5 are provided. The speaker 5 outputs sound corresponding to the sound data recorded in the memory card or the like which is built in the electronic camera. In addition, the LCD 6 and operation keys 7 formed on the side X2 are formed vertically (perpendicularly) below the finder 2, shooting lens 3, light emitting part 4, and speaker 5. Moreover, on a surface of the LCD 6, a so-called touch tablet 6A is formed which outputs position data corresponding to a position pointed to by a contacting operation of a predetermined pen type pointing device (referred as a proper pen) 6B.

Touch tablet 6A is composed of a transparent material, such as a glass or resin, so that the user can view though the touch tablet 6A the image shown in the LCD 6 formed inside the touch tablet 6A.

The operation keys comprise a plurality of keys corresponding to various kinds of functions that are described later, controlled by the pen type pointing device 6B, and used to control operations. Those operations include recording data, such as image data, sound data or text data recorded in a memory card, or the like. For example, a menu key 7A is operated to show a menu screen on the LCD 6, and an execution key 7B is operated to reproduce the recorded data selected by the user.

In addition, a clear key 7C is operated to delete the recorded data. A cancel key 7D is operated to scroll the screen vertically when a list of the recorded data is displayed on the LCD 6.

On the side Z that is the top side of the electronic camera 1, a microphone 8 collects sounds and an earphone jack 8 can be used to connect to an earphone (not shown).

On the left side (side Y1) a release switch 10 is operated for shooting the desired object, and a power switch 11 turns power on and off to the electronic camera. These release switch 10 and power switch 11 are arranged vertically (perpendicularly) below the finder 2, shooting lens 3, and the light emission part 4 which are provided on the upper part of the side X1.

On the side Y2 (right side) opposite side Y1, a recording switch 12 that is operated at the time of recording sounds and a continuous shooting mode switch 13 which is operated for switching the continuous shooting mode at the time of shooting the object, are provided. Recording switch 12 and continuous shooting mode switch 13 are arranged vertically (perpendicularly) below the finder 2, shooting lens 3 and light emitting switch, similarly to the above described release switch 10 and power switch 11. In addition, the recording switch 12 is arranged at substantially same height as the release switch 10 on the side Y1 so that the user does not feel awkward even when the electronic camera is held by the right hand or the left hand.

Moreover, the height of the release switch 10 and the recording switch 12 can be made different so that in case one of the switches is pressed by a finger, the other switch would not accidentally be pressed when the opposite side is held by another finger at the same time to cancel out the moment generated by the finger on the other side.

The above described continuous shooting mode switch 13 is used when setting whether the image is shot to be shot for just one frame or for a specified plurality of frames continuously, when shooting the object as the user presses the release switch 10. For example, when the release switch 10 is pressed when a pointer of the continuous shooting mode switch 13 is switched to a position indicated as “S” (that is, switching to an “S” mode), only one frame of picture is shot.

In addition, if the release switch 10 is pressed when the pointer of the continuous shooting mode switch 13 is switched to a position indicated as “L” (that is, switched to an “L” mode), the shooting is accomplished at a rate of 8 frames per second while the release button is being pressed. That is, shooting in a slow continuous shooting mode is performed.

Moreover, if the release switch 10 is pressed when the position of the continuous shooting mode switch 13 is switched to a position printed as “H” (that is, switched to an “H” mode), the shooting is accomplished at a rate of 30 frames per second while the release button is being pressed. That is, shooting in a fast continuous shooting mode is performed.

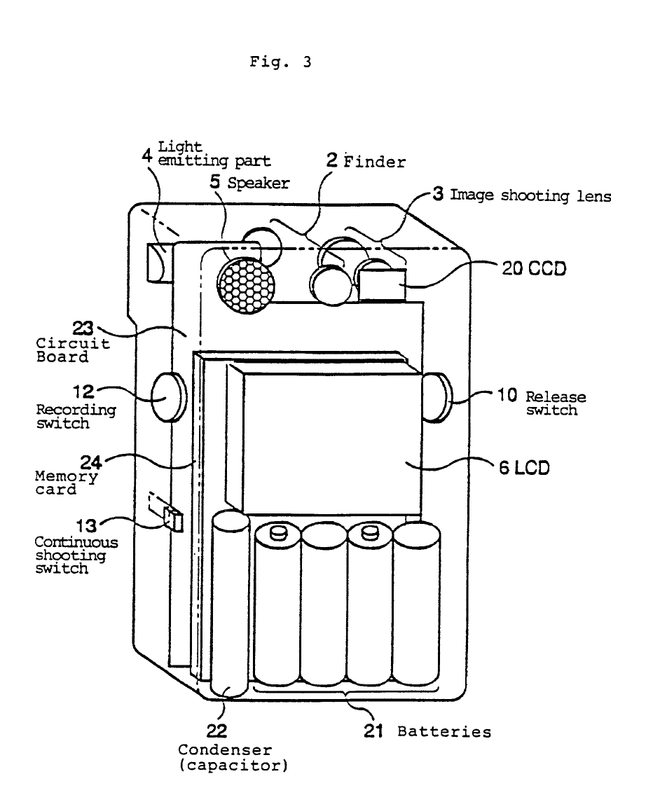

Next, the internal structure of the electronic camera 1 is described. FIG. 3 is a perspective view showing an example of internal structure of the electronic camera shown in FIG. 1 and FIG. 2. The CCD 20 is provided on a rear part (on the side X2) of the shooting lens 3 and constructed to photoelectrically convert the optical image of the object formed through the shooting lens into corresponding electronic signals (image signals).

Situated vertically (perpendicularly) below the LCD 6, four cylinder-shaped batteries (e.g. AA dry cells) 21, for example, are arranged to supply electricity. A condenser 22 that accumulates the electric charges (loads) needed when the light emission part 4 emits light, is arranged alongside the battery 21.

Various control circuits that control each part of the electronic camera 1 are formed on a circuit board 23. In addition, between the circuit board 23, LEC 6 and batteries 21, a memory card (recording medium) 24 that can be inserted or removed is provided, and various information input to the electronic camera 1 is recorded in each preset area of the memory card 24.

In addition, in the present embodiment, the memory card 24 is insertable and removable. However, memory can be provided on the circuit board 23, and various kinds of information can be recorded in the memory. In addition, it is also possible to output the various pieces of information recorded in the memory card (or memory) 24 to an external personal computer or the like through an interface (not shown in the figure).

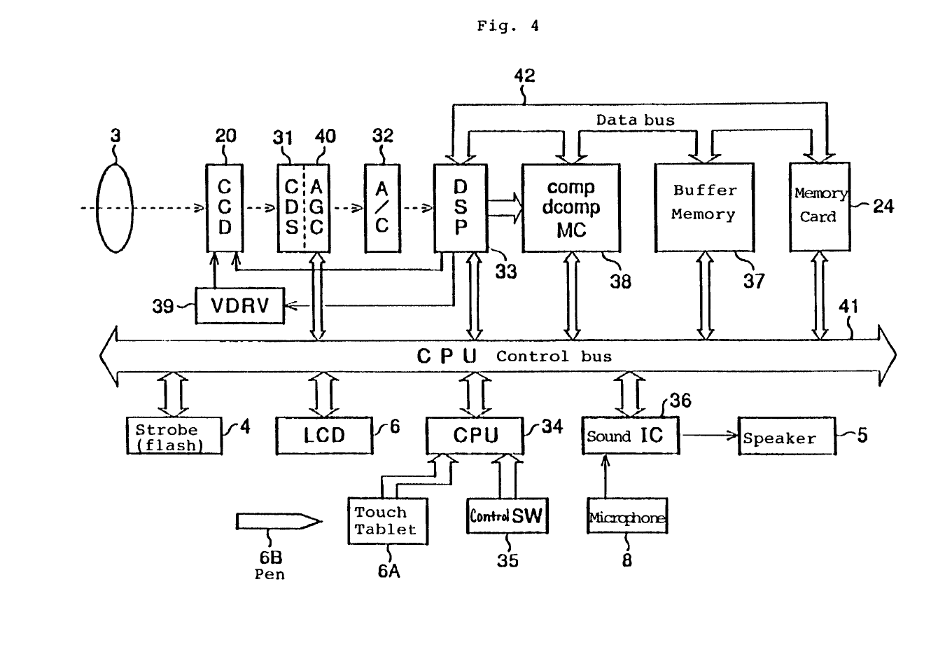

Next, an example of electrical structure inside of the electronic camera in the present embodiment is described with reference to a block diagram shown in FIG. 4. The CCD 29 that comprises a plurality of pixels photoelectrically converts an optical image formed on each pixel into image signals (electric signals). A CCD driving circuit (VDRV) 39 is controlled by a digital signal processor (DSP, described later) to drive the CCD 20.

A correlated double sampling circuit (referred as CDS hereafter) 3 samples the image signals converted by CCD 20. AGC (automatic gain control circuit) 40 controls the gain of the signal sampled by the CDS 31. An analog/digital converting circuit (referred as A/D converting circuit) 32 digitizes the signal sampled at CDS 31 and supplies it to a DSP 33.

The DSP 33 temporarily supplies and stores the digitized image data to a buffer 37. A compression/decompression memory control circuit (comp/dcomp MC) 38 reads the image data stored in the buffer memory 37, supplies it to the memory card 24 through a data bus 42 after compression by a JPEG (Joint Photographic Experts Group) format that is described later and records the compressed data in a specified area (image recording area).

In addition, the CPU 34 has a built-in timer circuit (not shown in the figure) which records date and time information when the pictures were shot as header information of the image data, in an image recording area of the memory card 24. That is, the shooting date and time are added to the image data recorded in the image recording area of the memory card 24.

The microphone 8 inputs sound and supplies sound signals corresponding to the sound to a sound IC 36. The sound IC 36 converts the sound signals supplied into digital sound data, supplies those signals to the memory card 24 after the data is compressed, and records the compressed data in a specified area (sound recording area). Data showing the date and time of recording is recorded in the sound recording area of the memory card 24 as header information of the sound data.

Moreover, the strobe (flash, light emission part) 4 is controlled by the CPU 34 and emits light at predetermined timing to irradiate light to the imaged object.

Furthermore, when a specified position on the touch tablet 6A is pressed by the pen-type pointing device 6B that the user operates, the CPU 34 reads XY coordinates corresponding to the position pressed on the touch tablet 6A and accumulates the coordinate data (composing a line-drawing information described later) in a specified memory (not shown in the figure) In addition, the CPU 34 supplies the line-drawing information accumulated in the memory with the header information, such as dates on which the line-drawing information was input, and supplies it to the memory card 24 to record it in line-drawing information recording areas.

Buffer memory 37 and the LCD 6 are connected to CPU 34 through a CPU control bus 41 so that images corresponding to the image data recorded in the buffer memory 37 can be displayed on the LCD 6. However, the image data that has been compressed is temporarily input to the compression/decompression memory control circuit 38 and then supplied to the buffer memory 37 through data bus 42 after it has been decompressed.

Moreover, the speaker 5 is connected to the sound IC 36. The sound data read from the memory card 24 is decompressed by the sound IC 36 and output from the speaker 5 after conversion to analog sound signals.

Furthermore, the operation switches (SW) 35 correspond to the release switch 10, the power switch 11, the recording switch 12, and the continuous shooting mode switch 13. When each switch is operated, corresponding signals are supplied to the CPU 34. Then, the CPU 34 executes corresponding specified processes, when each switch is operated.

Next, the operation of the electronic camera using the invention is described. First, input and output processes of sounds in the above embodiment are described. When the power switch 11 shown in FIG. 1 is switched to a side on which “ON” is printed, power is supplied to the electronic camera 1. As the recording switch 12 provided on the side Y2 is pressed, a recording process (processes that input and record sound) is commenced. That is, the sound input through the microphone 8 is converted to digital sound data by the sound IC 36, supplied to the memory card 245 after compression, and recorded in the sound recording areas of the memory card 24. At⁻ this time, data, such as recording date, is recorded as the header information of the compressed sound data in the sound recording areas of the memory card 24. The operations described above are repeatedly executed while the recording switch 12 is being pressed. For the compression method for the sound, PCM (Pulse Code Modulation) or other methods can be used.

Next, the operations for shooting the desired object are described. First, explanation is made when the continuous shooting switch 13 provided on the side Y2 is switched to the S mode (mode that shoots only one frame). As described in FIG. 1, the power switch 11 provided on the side Y1 is switched to the side at which the “ON” is printed, to turn on the power to the electronic camera 1. When the object is confirmed through the finder 2 and the release switch 10 provided on the side Y1 is pressed, the shooting process of the object is started.

The light image of the object observed through the finder 2 is collected by the shooting lens 3 and formed on the CCD 20, which comprises a plurality of pixels. The light image of the object formed on the CCD 20 is photoelectrically converted to image signals at each pixel and sampled by the CDS 31. The image signals sampled by the CDS 31 are supplied to the A/D converting circuit 32 after the gain is controlled through the AGC 40, and then digitized and supplied to the DSP 33.

The DSP 33 temporarily supplies the digitized image data to the buffer memory 37 to store. The compression/decompression memory control circuit 38 compresses the image data read from the buffer memory 37 in accordance with the JPEG method which combines the discrete cosine transformation (conversion), quantization, and Huffman encoding. The compression/decompression memory control circuit 38 supplies the compressed image data to the memory card 24 through data bus 42. The memory card 24 records in the image recording areas the image data supplied from the compression/decompression memory control circuit 38. At this time, the shooting dates data is recorded as the header information of the above image data in the image recording area of the memory card 24.

Moreover, when the continuous shooting mode switch 13 is switched to the S mode, only one frame is shot every time the release switch 10 is pressed. Therefore, even if the release switch 10 is pressed and held, only one frame is shot. In addition, if the release switch 10 is continuously pressed for a predetermined time, the image that is just shot is displayed on the LCD 6.

Next, a case in which the continuous shooting mode switch 13 is switched to the L mode (mode that continuously shoots 8 frames in one second) is described. When the power is supplied to the electronic camera 1 by switching the power switch 11 to the side at which “ON” is printed and when the release switch 10 provided on the side Y1 is pressed, object shooting processes are commenced as follows.

Light from the object observed through the finder is collected by the shooting lens 3 and formed on the CCD 20 comprised of a plurality of pixels. The light image of the object formed on the CCD 20 is photoelectrically converted to image signals at each pixel sampled by the CDS 31 at rate of 8 times per second. In addition, at this time, the CDS 31 thins out electric signals of the image that are relative to ¾ of the pixels among the electric signals of the images from the CCD 20 corresponding to the entire pixels.

The image signals sampled by the CDS 31 (image signals of pixels of the CCD 20 that is ¼ of the entire pixels) are supplied to the A/D conversion circuit 32. Then the image signals are digitized and output to the DSP 33.

The digitized image data is temporarily supplied to the buffer memory 37 by the DSP 33 and stored. The image data stored in the buffer memory 37 is read by the compression/decompression memory control circuit 38 and compressed in accordance with the JPEG method, as understood by persons skilled in the art. The image data compressed at the compression/decompression memory control circuit 38 is supplied to the memory card 24 through the data bus 42 and recorded in the image recording areas. At this time, the shooting date is recorded as header information of the above image data in the image recording areas of the memory card 24.

Next, the case in which the continuous shooting mode switch 13 is switched to the H mode (mode that continuously shoots 30 frames per second) is described. When the power is turned on to the electronic camera by switching the power switch 11 to the side at which “ON” is printed, and when the release switch provided on the side Y1 is pressed, the object shooting processes are commenced as follows.

The light from the object observed through the finder 2 is collected by the shooting lens 3 and formed on the CCD 20. The light image of the object formed on the CCD 20 comprised of a plurality of pixels is photoelectrically converted to image signals at each pixel and sampled by the CDS 31 at a rate of 30 times per second. In addition, at this time, the CDS 31 thins out electric signals of the images that are relative to 8/9 of pixels among the electric signals of the image from the CCD 20 corresponding to the entire pixels.

The image signals sampled by the CDS 31 (image signals of pixels that are 8/9 of the entire pixels of the CCD 20) are supplied to the A/D conversion circuit 32. Then the image signals are digitized and output to the DSP 33.

The DSP 33 temporarily supplies the digitized image data to the buffer memory 37 and stores. The compression/decompression memory control circuit 38 reads the image data from the buffer memory 37 and compresses it in accordance with the JPEG method. The image data that is digitized and compressed in such manner is supplied to the memory card 24 through the data bus 42 and recorded in the image recording area of the memory card 24 with the header information of the shooting date.

In addition, at the time of shooting the object, the strobe (flash or light emitting part) 4 can be operated to illuminate the object.

Next, a case when two dimensional information (pen input information) is input using the touch tablet 6A is described. When the pen tip of the pen type pointing device 6B is touched (contacted) to the touch tablet 6A, data that corresponding to the XY coordinate of the location of the contact is input to the CPU 34. The data corresponding to this XY coordinate is supplied to the CPU 34, and the image data corresponding to a point (dot) that has a specific size, for example, is written to a location of the buffer memory 37 that corresponds to the above XY coordinate by the CPU 34. Then, a point (dot) having a specified size is displayed at a location corresponding on the LCD 6 by controlling CPU 34.

As described above, since the touch tablet 6A formed on the surface of the LCD 6 is composed of a transparent material, the user can observe the point displayed on the LCD 6 at a location at which the touch tablet 6A was pressed by the pen tip of the pen type pointing device 6B, so that the user feels as if the user directly input the information using pen on the LCD 6. Moreover, if the pen type pointing device 6B is moved while it is contacting the touch tablet 6A, a line is displayed on the LCD 6 along the traces of the movement by the pen type pointing device 6B. Furthermore, if the pen type pointing device is intermittently moved on the touch tablet 6A, a broken line is displayed on the LCD 6 along the movement of the pen type pointing device 6B. As described above, the user can input desired line-drawing information, such as characters and figures, using the touch tablet 6A (LCD 6).

In addition, if the line-drawing information, such as characters, is input by the pen type pointing device 6B when an image is displayed on the LCD 6, the line-drawing information is composed with the image information at the buffer memory 37 and simultaneously displayed on the LCD 6.

The user can select colors, such as black, white, red or blue, of the line-drawing displayed on the LCD 6 from a plurality of colors by controlling a color selection switch that is not shown in the figure.

After inputting the line-drawing information accomplished by the pen type pointing device 6B and the touch tablet 6A, when the execution key 7B of the operation keys 7 is pressed, the line-drawing information accumulated in the specified memory is supplied to the memory card 24 through the CPU control bus 41 with the header information of input dates, and recorded in the line-drawing information recording areas of the memory card 24.

In addition, included in the line-drawing information that is recorded in the memory card 24 is information by which the compression of data was accomplished. Since the line-drawing information input to the touch tablet 6A includes a lot of information having high composition of spatial frequency, if the compression is accomplished using the JPEG method that is used for compressing the above images, the compression efficiency is not satisfactory, and thus the amount of information cannot be reduced much. In addition, JPEG compression is irreversible, so that it is not appropriate for the compression of line-drawing information that has small amount of information. This is because when the data is decompressed and displayed on the LCD 6, effects such as gathering, blurring and the like that accompany imperfection of information become prominent.

In the present embodiment, the line-drawing information is compressed by the run-length method that is used in facsimile machines and the like, as understood by persons skilled in the art. The run-length method is a method which compresses the line-drawing information by horizontally scanning the line-drawing screen and coding continuous lengths of information (points) in each of colors, such as black, white, red and blue, and continuous lengths of non-information (part in which there is no pen input).

By using this run length method, line-drawing information is efficiently compressed, and even when the compressed line-drawing information is decompressed, imperfection of information and display can be controlled. In addition, when the amount of line-drawing information is relatively small, the line-drawing information can be designated not to be compressed.

Moreover, as described above, when the image is displayed on the LCD 6, if the pen input is executed, the image data and the line-drawing information input by the pen are combined in the buffer memory 37, and the combined image of the image and line-drawing is displayed on the LCD 6. However, in the memory card 24, the image data is recorded in the image recording areas, and the line-drawing information is recorded in the line-drawing information recording areas. As described, since two sets of information can separately be recorded in deferent areas, the user can delete any one of image data or line-drawing information from the combined image of the image and line-drawing. In addition, each piece of image information can be compressed by different compression methods and recorded.

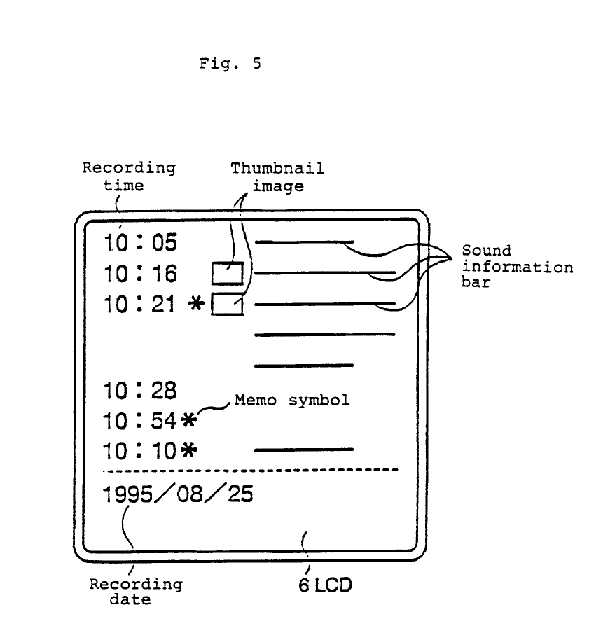

When data is recorded in at least any one of the sound recording area, image recording area, and line-drawing information recording area in the memory card 24, a listing screen showing a list of recorded information can be displayed on the LCD 6 as shown in FIG. 5. In the listing screen on the LCD 6 shown in FIG. 5, the recording date (in this case Aug. 25, 1995) is displayed on the lower part of the screen, and the recording time is displayed on the leftmost part of the screen.

On the right side of the recording time, thumbnail images are displayed when image data has been recorded. These thumbnail images are minimized images of the image data recorded in the memory card 24 which were created by thinning out bitmap data of each image data. The information that the thumbnail images display are information including image files. That is, image information is included in the information recorded (input) at “10:16” and “10:21,' and no image information is included in the information recorded at “10:05,” “10:28,” “10:54” or “13:10.” A memo symbol “*” indicates that a predetermined memo is recorded as the line-drawing information. Furthermore, on the right side of the display areas of the thumbnail images, sound information bars are displayed, in which bars (lines) having a specified length corresponding to the time during which the sound was recorded are shown. When there is no sound information recorded, this sound information bar is not shown.

In the screen shown in FIG. 5, the user selects and designates the information to be displayed by pressing rectangle area in which the desired information is shown with a pen tip of the pen type pointing device 6B, and designates displaying the selected information by pressing the execution key 7B shown in FIG. 2 with the pen tip of the pen type pointing device 6B. As a result, the selected information is output.

For instance, in the screen shown in FIG. 5, when the inside of a bar-shaped area at which “10:05” is displayed, the CPU 34 instructs the sound IC to play the sound corresponding to the selected recording time (10:05).

The sound IC reads the sound data from the memory card 24 in accordance with the instruction from the CPU 34 and outputs the sound data from the speaker 5 after decompressing and converting it to analog signals. In addition, when an earphone that is not shown in the figure is connected to the earphone jack 9, the sound is not output from the speaker but out from the earphone that is not shown in the figure.

When the image data recorded in the memory card 24 is displayed, the user selects the information of the image data by pressing a desired thumbnail image with the pen tip of the pen type pointing device 6B, and then instructs to display the selected information by pressing the execution key 7B.

The image data corresponding to the selected thumbnail image is read from the memory card 24 and decompressed in the compression/decompression memory control circuit 38. The decompressed image data is supplied to the buffer memory 37 through the data bus 42 and stored as bitmap data. Next, by CPU 34, control signals corresponding to the image data stored in the buffer memory 37 are supplied to the LCD 6, and the corresponding image is displayed.

At this time, when the sound data is also recorded (e.g. when the recording time is '10:16” or “10:21”), the sound can be output from the speaker 5 as described above.

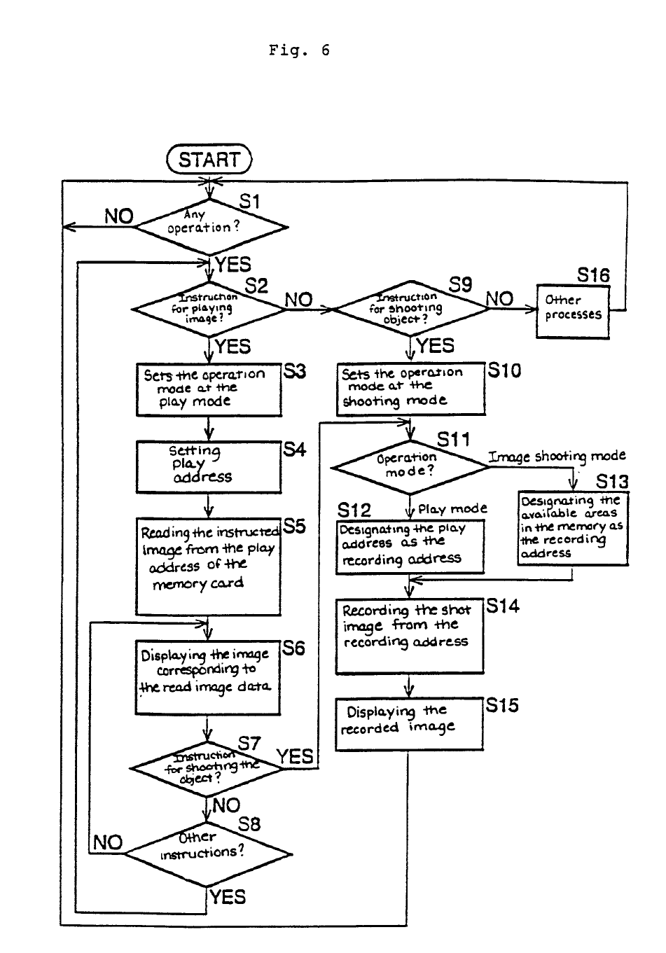

FIG. 6 is a flow chart explaining operations of the electronic camera 1 at the time of an instruction for shooting the desired object while the specified image data recorded in the memory card 24 is displayed on the LCD 6.

First, in step S1, a determination is made whether the control switch 35 or the touch tablet 6A has been operated by the CPU 34. When the determination is made that neither the control switch 35 nor the touch tablet 6A has been operated, the process returns to step S1 to repeatedly execute the process at step S1. On the other hand, if the determination has been made that either the control switch 35 or the touch tablet 6A has been operated, the process moves to step S2.

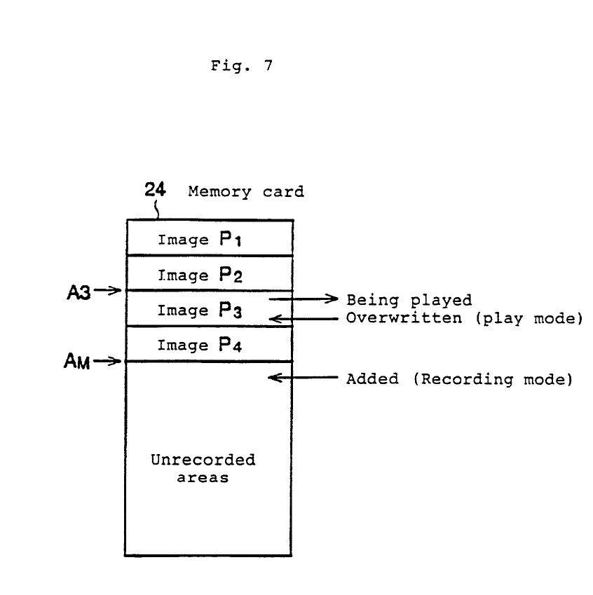

In step S2, the touch tablet 6A, pen 6B and operation keys 7 are operated as described above, and a determination is made whether an instruction for displaying a specified image has been made. When it is determined that there was the instruction for displaying the image data, the process moves to step S3, in which the CPU 34 sets the operation mode of the electronic camera 1. Next, in step S4, an address on the memory card at which the image designated to be displayed is set as a display address. Here, for example, displaying an image P₃ that is recorded in the memory card 24 shown in FIG. 7 is designated. In that case, the first address A₃ of an area in which the image data that corresponds to the image P3 is recorded is designated as the display address.

Then, the process moves to step S5, in which the CPU 34 instructs the compression/decompression memory control circuit 38 to read from the display address of the memory card 24 the image designated to display. The compression/decompression memory control circuit 38 reads the image data corresponding to the image instructed to be displayed through the data bus 42 from the display address of the memory card 24 in accordance with the instruction from the CPU 34, and temporarily supplies the image data to in the buffer memory 37 to store. In this case, the image P₃ that is recorded in the memory card 24 is read and supplied to the buffer memory 37.

In step S6, the CPU 34 controls the LCD 6 based on the image data supplied to the buffer memory 37 to display an image corresponding to the image data. In this case, the image P₃ is displayed. Then, the process moves to step S7, in which a determination is made by the CPU 34 whether the release switch 10 has been operated and shooting an image of the specified object has been designated. When the determination is made that the release switch 10 has been operated but that shooting the image of the specified object has not been designated, the process moves to step S8.

In step S8, a determination is made whether the control switch 35 or the touch tablet 6A has been operated and other instructions have been made. When the determination is made that other instructions have been made, the process returns to step S to repeatedly execute the processes after step S2. On the other hand, when the determination is made that any of the other instructions has not been made, the process returns to step S6 to repeatedly execute the processes after step S6.

If the determination is made that the instruction for shooting is made in step S7, the process moves to step S11, and the process for recording in the memory card 24 the image that is shot. The processes after step S11 will be described later.

In step S2, if the determination is made that the instruction for displaying the image has not been made, the process moves to S9. In step S9, a determination is made as to whether an instruction for shooting the object has been made. If the determination is made that there was an instruction for shooting, the process moves to step S10, in which the CPU 34 sets the operation mode the shooting mode.

Next, in step S11, a determination is made by the CPU 34 as to whether the operation mode is the shooting mode or the display mode. If the determination is made that the operation mode is the shooting mode, the process moves to step S13 to designates an address of an available area of the memory card 24, that is, an area in which an image data has not bee recorded (non-recorded area) (in case of an example in FIG. 7, address A_{M}), as a recording address.

On the other hand, when the operation mode is determined to be the display mode, the address on the memory card 24 in which the image data corresponding to the image currently being displayed on the LCD 6 (in case of the example in FIG. 7, address A3) is designated as the recording address, and the process moves to step S14.

First, in step S21, a determination is made by the CPU 34 as to whether the operation designated by operating the control switch 35 or the touch tablet 6A is an instruction for displaying, an instruction for shooting, or other instructions. If the determination is made that the instruction for displaying the image data is made, the process moves to step S22 and sets the address of the memory card 24 in which the image instructed to be displayed is stored as a display address. In this example, displaying the image P3 that is recorded in the memory card 24 shown in FIG. 7 is assumed to be instructed. In that case, the first address A₃ in the area in which the image data corresponding to the image P₃ is designated as a display address.

Next, as the process moves to step S23, the CPU 34 instructs the compression/decompression memory control circuit 38 to read an image that has been instructed to be displayed, from the display address of the memory card 24. The compression/decompression memory control circuit 38 reads the image data corresponding to the image to which the instruction for displaying is made, through the data bus 42 from the display address of the memory card 24 in accordance with the instruction from the CPU 34, and temporarily supplies the image data to the buffer memory 37 to store. In this case, the image P₃ that is recorded in the memory card 24 is read and supplied to the buffer memory 37.

In step S24, the CPU 34 controls the LCD 6 based on the image data supplied to the buffer memory 37 and displays the image corresponding to the image data. In this case, the image P₃ is displayed. Then, the process moves to step S25, in which a determination is made by the CPU 34 as to whether the release switch 10 is operated and an instruction has been made for shooting the image of the specified object. If the determination is made that the release switch 10 has been controlled and that there has not been any instructions for shooting the image of the specified object, the process moves to step S26.

In step S26, a determination is made as to whether the control switch 35 or the touch tablet 6A is operated, and other instructions are made. When the determination is made that other instructions have been made, the process returns to step S21 to repeat the processes after step S21. On the other hand, if the determination is made that any other instructions has not been made, the process returns to step S24, and processes after step S24 are repeatedly executed.

If the determination has been made in step S25 that there has been an instruction for shooting the image, the process goes to step S27. Then, an address (play address) on the memory card 24 in which the image data corresponding to the image currently being displayed is designated (in a case of the example shown in FIG. 7, address A₃) as a recording address, and the process moves to step S28.

In step S28, the image that is shot is recorded from the recording address of the memory card 24. Therefore, in this case, the image data corresponding to the image currently being displayed is overwritten by the image data corresponding to the image that has just been shot.

Next, in step S29, an image recorded in the memory card 24 is displayed on the LCD 6. Then, the process returns to step S21 to repeat the processes after step S21.

Moreover, in step S21, if the determination is made that there has been an instruction for shooting the specified object and for recording the image data in the memory card 24, the process moves to step S30, in which the CPU 34 detects an address of an available area of the memory card 24, that is, an area to which no image has been recorded and designates the address as the recording address. In case of the example shown in FIG. 7, the address A_{M} is designated as the recording address.

Then, the process moves to step S28 and records the image that is shot, from the recording address of the memory card 24. In case of the example shown in FIG. 7, the image corresponding to the image that is shot is recorded from the address A_{M}. That is, the image data is added in an area of the memory card 24 in which no image has been recorded. Thereafter, the process moves to step S29 to display image recorded in the memory card 24 in the LCD 6.

In addition, in step S21, if the determination is made that other operations have been instructed, the process moves to step S31 and executes other operations. Then, the process returns to step S21 and repeats the processes after step S21.

As described above, when the release switch 10 is operated and an instruction for shooting an image is made while the specified image is being displayed, the image that is shot is overwritten in the area of the memory card 24 from which the image is currently being displayed. Therefore, a construction can be made so that when an object that is desired to be shot suddenly appears while a specified image is displayed on the LCD 6, an image of the object can be shot just by operating the release switch 10 and recorded in the memory card. Shutter chances therefore are not missed.

On the other hand, when there is an image to be deleted, it can be displayed on the LCD 6. Then, by operating the release switch 10 to shoot an image of the desired object, the image that is just shot can be overwritten in the area in the memory card 24 in which the image being displayed on the LCD 6 is recorded. Therefore, operations for deleting the image being displayed on the LCD 6 can be omitted, and thus operation of the camera can be simplified.

In the above embodiment, each piece of information is input using a pen type pointing device. However, a finger can be used for inputting the information.

Furthermore, the display screen shown in the LCD 6 is an example, and the present invention is not limited to this configuration. It is possible to use screens with different layouts. Similarly, the types and layouts of the operation keys are also examples, and the present invention is not limited to that illustrated configuration either.

Moreover, in the above embodiment the image that is shot is overwritten in the area of memory card 24 in which the image being displayed is recorded, as the release switch 10 is operated. However, the image can be stored to an area in which no previous image data is recorded.

Furthermore, the image being reproduced or displayed does not need to be actually erased simultaneously with the recording of the shot image. The image being reproduced only needs to be set to an erasable condition simultaneously with the recording of the shot image. The erasing and overwriting of the image being reproduced can occur any time, for example when the memory becomes full.

As described above, according to the information input device of the invention, since the control part is constructed to store to the memory the image that is shot by the imaging part when there is an instruction from the first instruction part to store to the memory the image shot by the imaging part while the reproducing part is displaying a specified one of the images instructed to be displayed by the second instruction part, specified images can be shot even while other images are being displayed, so that the operations can be simplified. Thus no shutter chances are missed due to this effect.

What is claimed is:

1. An information input apparatus comprising:
imaging means for shooting images of objects;
memory means for storing the images shot by said imaging means;
reproducing means for reproducing the images stored in said memory means;
control means for controlling the storage of the images shot by said imaging means into said memory means, and the reproduction of at least a predetermined one of the images stored in said memory means, by said reproducing means;
first instruction means for instructing said controlling means to store the images shot by said imaging means to said memory means; and
second instruction means for instructing said reproducing means to reproduce at least a predetermined one of the images stored in said memory means;
wherein said control means stores in said memory means the images shot by said imaging means when there is an instruction from said first instruction means to store in said memory means the images shot by said imaging means, while said reproducing means is reproducing a predetermined one of the images instructed by said second instruction means.

2. The information input apparatus described in claim 1, wherein said control means overwrites the image shot by said imaging means in a predetermined area of said memory means in which the predetermined one of the images that said reproducing means is reproducing is recorded, when there is an instruction from said first instruction means to store in said memory means the images shot by said imaging means, while said reproducing means is reproducing a predetermined one of the images instructed by said second instruction means.

3. The information input apparatus described in claim 2 further comprising display means for displaying the images shot by said imaging means and the image stored in said memory means.

4. The information input apparatus described in claim 3 further comprising illumination means for illuminating light onto the object.

5. The information input apparatus described in claim 4 further comprising sound input means for inputting sound, wherein said memory means stores the sound input from said sound input means.

6. The information input apparatus described in claim 5 wherein said memory means stores and relates the images and sounds.

7. The information input apparatus described in claim 1 wherein while said reproduction means is reproducing an image, the data for the image being reproduced is set to an erasable condition while a newly shot image is recorded.

8. An method for inputting image information comprising the steps of:
shooting images-of objects;
storing the images shot in a memory;
controlling the storage of the images shot into memory, and the reproduction of at least a predetermined one of the stored images, according to:
(a) a first instruction for instructing the storage of the images shot to memory; and
(b) a second instruction for instructing the reproduction of at least a predetermined one of the images stored in memory;
wherein said step of controlling stores in memory the images shot when there is the first instruction to store in memory the images shot, while said step of reproducing is reproducing a predetermined one of the images instructed by the second instruction.

9. The method described in claim 8, wherein said step of controlling overwrites the image shot in a predetermined area of memory in which the predetermined one of the images being reproducing is recorded, when the first instruction instructs to store in memory the images shot, while said step of reproducing is reproducing a predetermined one of the images instructed by the second instruction.

10. The method described in claim 9 further comprising the step of displaying the images shot and the image stored in memory.

11. The method described in claim 10 further comprising the step of illuminating light onto the object.

12. The method described in claim 11 further comprising the steps of inputting sound, and storing the sound input in memory.

13. The method described in claim 12 further comprising the step of relating the images and sounds in memory.

14. The method described in claim 8 wherein while said reproduction of an image, the data for the image being reproduced is set to an erasable condition while a newly shot image is recorded.

15. An information input apparatus comprising:
an imaging part for shooting images of objects;
a memory part, connected to said imaging part, for storing the images shot by said imaging part;
a reproducing part, connected to said memory part, for reproducing the images stored in said memory part;
a control part, connected to said memory part and said reproducing part, for controlling the storage of the images shot by said imaging part into said memory part, and the reproduction of at least a predetermined one of the images stored in said memory part, by said reproducing part;
an instruction part, connected to said control part, for instructing said controlling part to-store
the images shot by said imaging part to said memory part according to a first instruction, and
reproduce at least a predetermined one of the images stored in said memory part, according to a second instruction;
wherein said control part stores in said memory part the images shot by said imaging part when there is an instruction from said instruction part to store in said memory part the images shot by said imaging part, while said reproducing part is reproducing a predetermined one of the images instructed by said instruction part.

16. The information input apparatus described in claim 15, wherein said control part overwrites the image shot by said imaging part in a predetermined area of said memory part in which the predetermined one of the images that said reproducing part is reproducing is recorded, when there is the first instruction from said instruction part to store in said memory part the images shot by said imaging part, while said reproducing part is reproducing a predetermined one of the images instructed by said instruction part, according to the second instruction.

17. The information input apparatus described in claim 16 further comprising a display part for displaying the images shot by said imaging part and the image stored in said memory part.

18. The information input apparatus described in claim 17 further comprising an illumination part for illuminating light onto the object.

19. The information input apparatus described in claim 18 further comprising a sound input part for inputting sound, wherein said memory part stores the sound input from said sound input part.

20. The information input apparatus described in claim 19 wherein said memory part stores and relates the images and sounds.

21. The information input apparatus described in claim 15 wherein while said reproduction part is reproducing an image, the data for the image being reproduced is set to an erasable condition while a newly shot image is recorded.
